(19) United States
(12) Patent Application Publication
(10) Pub. No.: US 2014/0032356 A1
(43) Pub. Date: Jan. 30, 2014

(54) METHOD AND SYSTEM FOR SELLING CUSTOM PRODUCTS

(71) Applicants: Hsijung CHUANG, Taichuan (TW); Ranjan MADA, Brea, CA (US)

(72) Inventors: Hsijung CHUANG, Taichuan (TW); Ranjan MADA, Brea, CA (US)

(21) Appl. No.: 13/559,529

(22) Filed: Jul. 26, 2012

(51) Int. Cl. G06Q 30/00

(52) U.S. Cl. 705/26.5

(57) ABSTRACT

A method for offering a customizable product for sale is provided. The method includes grouping the product by type into one or a plurality of category; determining a fixed price for the product in each category; offering the product category for sale in a store; receiving a payment for the fixed price from a customer at the store; surveying the customer's requirements after receiving the payment; manufacturing the custom product based on the surveying result; and delivering the custom product to the customer, wherein the fixed price reflects the total cost for the custom product.

### FIELD

The present invention relates generally to providing a simplified and improved retail model, and more particularly, to methods and systems of selling custom products such as window covering products.

### BACKGROUND

In the retail business, customers are often discouraged from making a purchase when they are not sure if a product fits their needs, if they do not have sufficient information (e.g., exact price) on the product or if the shopping experience is overly complicated. This is unlike a problem in the retail of general merchandise such as toothpaste or toys. Typically, stores can simply present samples of the different toothpastes and toys with their respective prices on their shelves. Potential customers can make instant purchase decisions based on the product selections and their prices. The transaction is complete when customers pay for the goods at the cashier. No follow up from the retailer or the manufacturer is generally necessary.

For certain types of merchandise (e.g., window covering products) that require customization and optional installation/follow-up services after the initial store visit, the ordering process can be complicated and lengthy. For example, in a typical shopping experience of custom window covering products, a shopper may not know exactly how much he/she will be paying for the product after a visit to the store or even after he/she has made an initial payment. Because window covering products can be highly customizable, it may require multiple visits to the store and/or home visits to complete the purchase process. As such, the shopping experience can be a hassle for the customer and discourage him/her from going through with the purchase. Or, since the price transparency is not immediately evident, it may dissuade potential consumers from considering purchasing custom window covering products because they may perceive it to be unaffordable. Retailers selling products such as window covering products are also facing challenges as the highly-customizable nature of the products may require large display and storage space and highly-trained staff to provide a satisfying experience for customers. Some of the conventional solutions that work well with general merchandise cannot be easily applied to the retail of products, such as window covering products, that require customization/follow-up service.

To appreciate the advantages of the methods and systems of this invention, we first discuss in more detail the current retail models for custom products such as window covering products and the shortcomings of these existing models.

Window covering products are readily sold in home improvement stores, e.g., Home Depot, other retail stores, e.g., Wal-Mart, K-Mart, Sears, and JC Penney, etc. (referred to hereinafter as “store” or collectively referred to hereinafter as “stores”). These products are currently sold in various stock programs, cut-down programs, and custom programs.

With stock programs, manufacturers sell certain common size window covering products which are displayed in the retail stores. These stock programs usually only offer products in a fixed number of types and/or shapes. These stock-size products are typically finished products that are not typically fully customizable, if at all. Customers can select a finished product for purchase in the store and then either install it themselves or contract professional installers or handymen to install the product for them.

Because the window covering products offered in these stock programs are non-customizable finished products, customers need to measure their window/door openings before they visit the store to select the product with the right size. Measuring a window/door opening to buy the right-size covering product can be a difficult task. Depending on the type of window covering product (e.g., shutters versus blinds) to be purchased, or the way it will be installed (e.g., inside-mounted versus outside-mounted), the measurement can require different deductions. Moreover, because window/door openings do not all have a standard measurement due to different specifications applied by the builder, there may not be a stock window covering product that fits a particular opening perfectly. The customer may not realize that the product does not fit until after he/she tries to install it. This can add inconvenience and frustration to the shopping experience if the customer has to make addition trips to the store to exchange or return the products, which increase the handling and overhead of both stores and manufacturers.

In addition, stock programs need substantial physical inventories either at the cost of the manufacturer or the store because each of these fixed models has to be available in the store. They also require significant display space in stores to display samples of the different types of stock products in different sizes and colors. This can also add to the retailers' overhead for running a stock program.

Cut-down programs may offer more flexibility than stock programs, but it has its own shortcomings. A typical cut-down program has the manufacturer sell certain common size window covering products to stores, together with cut-down machines to be installed in each store. Customers can choose a window covering product with a particular length that roughly fits their needs, and then ask a store associate to cut down the product to a certain width to match exactly with the width of their window openings using the on-site cut-down machine. However, the length usually is not customizable and usually is longer than the desired length.

Cut-down programs have the overhead associated with the installation and maintenance of the cut-down machines and the training required for the store associates to operate the machines properly and safely. The currently-available cut-down machines also have their limits. In particular, the edge areas of the products that can be cut are usually limited by the machine and the product specification itself, and the machine is not designed to adjust the lengths of products. As with the stock program, customers are also required to measure their windows/doors first before visiting the store and the measurement may not always be accurate.

Existing custom programs offer the most flexibility, but are also the most expensive. Typically, with custom programs, stores display certain samples of the products, but do not maintain any inventory of the products in the store. Customers can browse the samples displayed in stores. Because the products can be customized in a number of different ways (e.g., by size, color, etc.), customers often need store associates' assistance to decide which product is best suited for their needs and find out how the product can be customized. Again, this requires the store associates be well-trained about the products and the custom programs to be able to assist customers.

Once customers decides on a product, the store associate records the customer's contact information and, at a later time, sends a professional staff or installer to the customer's home to make the necessary measurements. Only after the measurements are made, can the customer find out about the final price of their custom shutters, shades or blinds. If the customer accepts the price quote and pays for it, the custom shutters, shades or blinds is then manufactured and shipped to the customer to be installed. If the customer does not accept the price quote, there might have no sales as a result. This will increase the overall cost of the service provider and the burden the total supply chain.

Because window covering products purchased through the existing custom programs are manufactured according to measured size of each window/door opening, it is unlikely that they would not fit when installed. Nevertheless, stores are hesitant to introduce custom programs/products since they usually require a substantial upfront investment to build a system for ordering and processing of the products with multiple options, and to train store associates to learn the various products so that they can educate and assist customers when they make their purchases. In addition, the current ordering process, as described above, is complicated and lengthy and need back and forth communication between the store, manufacturer and consumer. Consumers often cannot finalize a purchase with one visit to the store and do not know the exact final price of the purchase when they leave the store. Furthermore, to showcase the products and the different ways they can be customized, stores still have to allocate significant display space. This may further increase the overhead of the store for running a custom window covering product program. In short, all of the shortcomings of the existing programs described above can create barriers for entries to the retail market for the manufacturer and barriers for the retail stores to maximize sales.

Embodiments of this invention provide various solutions for the issues identified above.

### SUMMARY

Current invention allows consumers to complete the purchase of a custom window covering products in a single store visit. This process can substantially lower the cost of the custom products, shorten the lead-time, and since more stores will be able and willing to offer custom product programs, it encourages competition among stores to lower the price and thus ultimately benefit consumers. At the same time, since stores generate more sales, they also benefit from this simple process. Manufacturers are also benefiting since they can sell more products with a properly set price.

In general, the present invention relates to systems and methods for selling customizable products such as window covering products. Although the detailed embodiments disclosed below are described in the context of the retail of window covering products, it should be understood that the disclosed systems and methods are not so limited, but can be easily adopted in the retail of other types of products including, for example, other types of custom home improvement products. In this document, window covering products can refer to any type of items for covering windows, door openings, or other types of openings at a residence or a commercial establishment. Window covering products can provide both privacy and decorative purposes. Various window covering products can include, but are not limited to, blinds, shades, shutters, and draperies.

### BRIEF DESCRIPTION OF THE DRAWINGS

FIG. 1 is a flow chart illustrating exemplary steps in a method of selling custom products such as window covering products according to embodiments of this invention.

FIG. 2 illustrates the exemplary components of a computer that can serve as a central server storing product information such as product categories and sizes according to embodiments of the invention.

FIG. 3 illustrates an exemplary database table for storing custom product information according to embodiments of the invention.

FIG. 4 illustrates the exemplary components of a computer network for supporting a custom product program offering according to embodiments of the invention.

### DETAILED DESCRIPTION

In the following description of preferred embodiments, reference is made to the accompanying drawings which form a part hereof, and in which it is shown by way of illustration specific embodiments in which the disclosure can be practiced. It is to be understood that other embodiments can be used and structural changes can be made without departing from the scope of the embodiments of this disclosure.

Current invention allows consumers to complete the purchase of a custom window covering products in a single store visit. This process can substantially lower the cost of the custom products, shorten the lead-time, and since more stores will be able and willing to offer custom product programs, it encourages competition among stores to lower the price and thus ultimately benefit consumers. At the same time, since stores generate more sales, they also benefit from this simple process. Manufacturers are also benefiting since they can sell more products with a properly set price.

In general, the present invention relates to systems and methods for selling customizable products such as window covering products. Although the detailed embodiments disclosed below are described in the context of the retail of window covering products, it should be understood that the disclosed systems and methods are not so limited, but can be easily adopted in the retail of other types of products including, for example, other types of custom home improvement products. In this document, window covering products can refer to any type of items for covering windows, door openings, or other types of openings at a residence or a commercial establishment. Window covering products can provide both privacy and decorative purposes. Various window covering products can include, but are not limited to, blinds, shades, shutters, and draperies.

Embodiments of the invention are designed to break down the aforementioned barriers for entries to the retail market for the manufacturer and barriers for the retail stores to maximize sales by simplifying the shopping experience for customers shopping for window covering products (or other types of custom products) and, at the same time, minimizing stores' overhead, thus incentivizing stores to offer the custom products and maximizing sales.

In particular, according to the disclosure, window covering products (or other types of custom product) can be grouped into a limited number of categories based on, for example, their types. Each category can be assigned a fixed price. When a customer visits the store, he/she can choose a window covering product in one particular category offered by the store and pay the fixed price to complete the purchase on the spot. Thereafter, an order reflecting the purchase can be sent to the manufacturer, who, upon receiving the order, can arrange for professional personnel to visit the customer's home if required to measure the size of the window/door openings and then manufacture the purchased window covering products based on the measurement, ship them to the customer, and even help with the installation if consumers so require.

In contrast with the custom programs being offered currently, the disclosed method allows the customer to choose the window covering product of his/her choice and figure out the exact cost associated with the purchase in a single store visit, without the hassle of having to take measurements before the store visit or not knowing exactly how much the purchase is going to cost until after the order is entered and the product manufactured. Customers can pick the products of their choice without having to worry if the products will fit. The whole in-store shopping experience can be as simple as going to a pharmacy to buy a toothpaste, for example. Stores can reduce the need for large display areas because only a limited number of categories of products are offered and displayed. Customer can select their exact choice of color and style in a number of ways which do not require an additional store visit. The manufacturer's representative can even provide samples during the in-house visit after consumer's initial store visit or samples can be sent to the consumer for selection. They can also reduce overhead by not having to train their sales associates to learn every detail about the product and the different ways they can be customized.

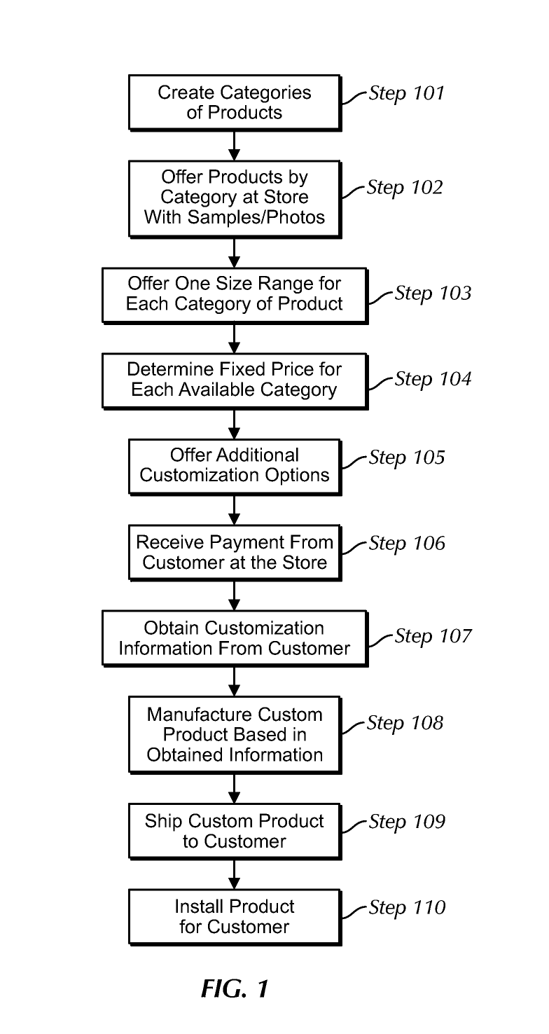

FIG. 1 is a flow chart illustrating exemplary steps in the method of selling custom window covering products according to embodiments of this invention.

First, the window covering products can be divided into a number of categories (step 101). The categories can be created based on one or more characteristics of the products. For example, each category can correspond to a certain type of window covering products. Exemplary categories can include, for example, aluminum venetian blinds, faux wood venetian blinds, single-cell cellular shades, double-cell cellular shades, roller shades, roman shades, plastic shutters, MDF shutters, and wood shutters. Preferably, the number of categories can be kept relatively low. This can simplify the selection process for customers and at the same time minimize the display space required at the store.

Stores offering the products can display one or more samples of the products in each category and/or have photos of the products showing each product (step 102). For example, the store can display a sample of each of the aluminum venetian blinds, faux wood venetian blinds, single-cell cellular shades, double-cell cellular shades, roller shades, roman shades, plastic shutters, MDF shutters, and wood shutters. The samples do not have to be shown in any particular size. However, stores can offer one standard size range for each category of products and offer to customize the product to fit customers' need after customers purchase the products (step 103). Each category can be assigned a specific stock keeping unit (SKU) number. If a customer decides to purchase window shades for his home, he/she does not need to worry about his/her window size, can just pick a product category.

A price tag indicating the price for each available category can be readily listed (step 104) with the samples in each category. Preferably, the list price is the only price the customer has to pay for his/her custom window covering product. That is, the list price for a particular category of window covering product includes the full price for the custom product, or the product plus additional optional service, and the follow-up service to customize the product based on the customer's needs. The customer does not have to pay extra for the surveying the window/door at his/her home and the customization. The fixed price may also include shipping cost of the final custom product. As a result, the customer can know exactly how much a custom window covering product would cost him/her when he/she makes the purchase at the store. There is no hidden cost for the customer to worry about. In one embodiment, a separate price for the optional installation service can also be listed for each sample offered in the custom program. In this case, another SKU number can be assigned to the installation service. Because the price for each product category is readily available to the customer at the store and there is no addition charge after the customer orders his/her customer products, it provides an instant affordability index to the customer. As a result, the custom program disclosed in this embodiment can simplify the shopping experience significantly for customers and increase the likelihood of customers making a purchase during their first visits to the store.

Additionally or alternatively, the disclosed method can allow the customer to further customize his window covering products by, for example, choosing a specific color, control mechanism or other options (step 105). These selections can be included already in the fixed price, or they can be offered as options each with a fixed and displayed price that customer can choose and add-on at the store. These selections can be made as a part of his/her purchase order at the store. Alternatively, the customer can log onto the manufacturer's website to select the additional options to further customize the product after his/her visit to the store. For example, a customer can either pick a free small color swatch at the display place in the store or he can pick a color on the manufacturer's web site afterwards using the order number obtained during the check-out process.

When the customer is ready to make the purchase, he/she can give the SKU number(s) associated with the product in a particular category (and the optional add-ons and/or installation service) to the cashier at the check-out counter and pay the set price (step 106).

After the customer selects a product in one of the standard categories at the store and pays the list price for it, an order can be sent to the manufacturer, who can then send a professional to the customer's home to measure the sizes of the window/door openings and obtain other necessary information for customizing the purchased product (step 107). As described above, this service can be covered by the price paid by the customer in the store. After the measurements are made, the manufacturer can then manufacture the custom window covering product (step 108). Once made, the custom window covering product can be shipped to the customer for installation (step 109). If the customer has elected the optional installation service, the manufacturer or the store can send a professional to the customer's home to install the product (step 110). Again, because the customer already paid for this optional service at the store, no additional charge is assessed when the installation actually takes place.

In short, the method for selling custom window covering products (or other types of custom products) disclosed in the above embodiments can offer a number of advantages over existing custom programs. First, it can make the shopping experience much simpler for customers. Customers do not have to measure their window/door openings before or after visiting the store. The limited number of category options offered at the store can make it less challenging for the customer to decide on a particular product. More importantly, the customer can find out exactly how much it will cost him/her to purchase the product at the store. He/she does not have to be concerned about any addition costs that are often unknown until at a much later time under the existing programs. All these improvements can significantly transform the shopping experience for customers looking to by custom products such as window covering products by making it as simple and hassle free as buying a toothpaste. As a result, customers can become more willing to consider ordering custom window covering products from stores which offer such a simple program and process.

The disclosed embodiments can also encourage more retail stores currently not offering custom programs to offer custom programs for products such as window covering products so to fully maximizing their sales potential. Because only a limited number of categories are offered, the store can allocate less space than if it were to offer the existing standard program which requires displaying a large number of different products in different sizes and colors. Furthermore, the simplicity of only offering certain categories of products and having a single price for each category can reduce the need to train store associates about the different products, pricing, and other related services to run the programs. This can significantly reduce the overhead associated with the existing custom programs and translate into additional sales and profits for stores. As a result, stores can be more willing to offer customer programs, which, in turn, will benefit consumers, retailers and manufacturers.

In one embodiment, manufacturer can even assign a unique ID# for each window opening of a specific customer and his/her address, which can be affixed on the product and stored in a data base to allow for future window covering product purchases according to the stored window size and specifications electronically stored.

In another embodiment, one or more of the exemplary steps in the process shown in FIG. 1 can be performed using a computer system. For example, computer systems can be used for determine a proper and profitable fixed price for each product category, managing the categories of products for the manufacturer/retailer and, for the customer, selecting options for a particular products and/or scheduling follow-up appointments for survey and installation.

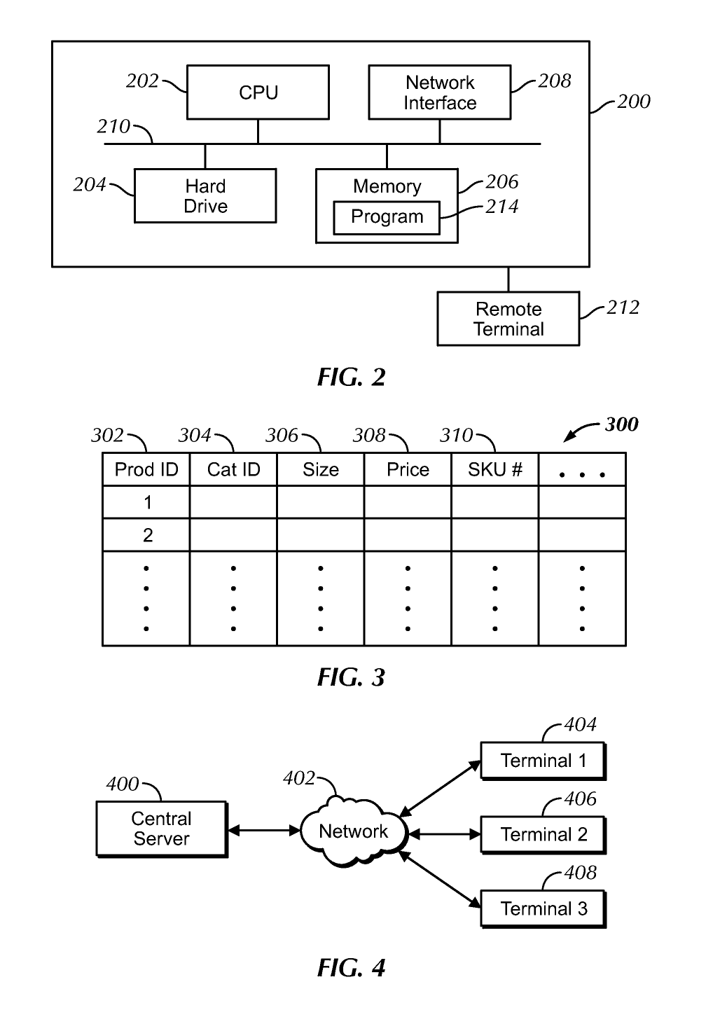

FIG. 2 illustrates the exemplary components of a computer 200 that can be used as a central server for the manufacturer. As illustrated, the computer 200 can include a central processing unit (CPU) 202, hard disk drive 204, memory 206, and network interface 208, all of which can be connected to each other via a system bus 210. The central server 200 can host a database server (not shown). The database server can have installed on it a database (e.g., MS Access, MS SQL Server, etc.) for maintaining a record of the categories for one or more custom products offered by the manufacturer. The database can optionally store other product related information such as inventory and other customization options. In this embodiment, as illustrated in FIG. 2, one or more programs 214 required for maintaining and accessing the product database can be stored in the memory 206 of the computer 200.

One or more local or remote terminals 212 can be connected to the central server 200 for providing a user interface for receiving user input regarding the product categories and other information.

In one embodiment, the user interface can be provided for a user to create, edit, and/or remove one or more categories (and other customization options) from the database. For example, when creating a new category, a user can enter the product type, the size range offered for each category, and the fixed price for each category. This information can be remotely accessible by the retail stores. The categories and prices can be modified after being entered in the database.

FIG. 3 illustrates an exemplary database table structure 300 in the database on the central server 200 for storing product information. The table in FIG. 3 can include one or more exemplary columns entitled “Product ID” 302, “Category ID” 304, “Size” 306, “Price” 308, and “SKU Number” 310. The table can also include one or more other columns “Color,” “Control Mechanism,” etc. It should be understood that FIG. 3 merely illustrates one example of the database table in the central server. In various embodiments, one or more of the columns can be optional. The database can include additional columns to capture other types of product information. The type of database systems used can also vary in different embodiments of the invention.

Referring back to FIG. 2, one or more programs for maintaining and accessing the product database can be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer-readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The one or more terminals 212 can be connected to the central server 200 for users to access and retrieve information from the central server 200. At least one of the terminals 212 can be local. Additional terminals 212 can be connected to the central server 200 over a network. FIG. 4 illustrates an exemplary network 402 including a central server 400 hosting a product database according to an embodiment of this invention. Multiple remote terminals 404, 406, 408 can be connected to the central server 400 via a computer network 402. Although only three remote terminals 404, 406, 408 are shown in FIG. 4, it should be understood that the network 402 can be configured to support a different number of remote terminals.

The remote terminals 404, 406, 408 can be located at the manufacturer, retail stores, and/or customers' homes. The manufacturer, retailers, and customers can be assigned with different permissions for access the central server. For example, the manufacturer can be given full permission to edit the product categories, size range, prices, and other information in the database table. The retail stores can have permission to view the product categories, but not to make any changes in these fields. However, the retail stores can edit the SKU number and/or the price. The customer may be able to access other fields of the database. As described above, the customer may select options such as color and control mechanism for the product they have purchased.

The computer network 102 can be any existing network including, but not limited to, a local area network (LAN), wide area network (WAN), cellular network, WiFi network, and other wireless networks. In some embodiments, the network 102 can be a public network such as the internet. For example, customers may be able to customize their window covering products via the manufacturer's website after their visit to the store. Additionally or alternatively, they can set up appointments for survey and installation services. In other embodiments, the network 102 can be a dedicated network (e.g., a virtual private network (VPN)) for increased security.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A method for offering a customizable product for sale, comprising:
determining a fixed price for a custom product;
offering the custom product for sale in a store;
receiving a payment for the fixed price from a customer at the store;
surveying the customer's requirements after receiving the payment;
manufacturing the custom product based on the surveying result; and
delivering the custom product to the customer,
wherein the fixed price reflects the total cost for the custom product.

2. The method of claim 1, further comprising offering at least one additional option to customize the custom product.

3. The method of claim 2, wherein the additional option is a choice of color.

4. The method of claim 2, wherein the additional option can be chosen after the store visit at no additional charge.

5. The method of claim 4, wherein the additional option is offered on a website or through home delivery.

6. The method of claim 1, wherein the custom product is a window covering product.

7. The method of claim 6, wherein the types of window covering product comprising at least one of blind, shade, and shutter.

8. The method of claim 6, wherein the categories includes at least one of aluminum venetian blinds, faux wood venetian blinds, single-cell cellular shades, double-cell cellular shades, roller shades, roman shades, plastic shutters, MDF shutters, and wood shutters.

9. The method of claim 1, wherein the fixed price includes shipping cost.

10. The method of claim 1, further comprising offering an optional installation service.

11. The method of claim 1, further comprising:
determining a surcharge for the optional installation service; and
offering the optional installation service at the store.

12. A non-transitory computer-readable storage medium storing a program for offering a customizable product for sale, the program, when executed by a processor, performs the steps of:
grouping a custom product by type into a plurality of categories;
offering the custom product in each of the plurality of categories in a number of sizes;
determining a fixed price for the offered size for the custom product in each category;
offering the categories of custom product in the at least one size in a store; and
receiving an order from a customer for a custom product in one of the categories in one particular size,
wherein the fixed price reflects the total cost for the custom product.

13. The non-transitory computer-readable storage medium of claim 12, wherein the processor further performs the step of offering at least one additional option to customize the custom product.

14. The non-transitory computer-readable storage medium of claim 13, wherein the additional option is a choice of color.

15. The non-transitory computer-readable storage medium of claim 13, wherein the additional option can be chosen after the order is received and at no additional charge.

16. The non-transitory computer-readable storage medium of claim 13, wherein the processor further performs the step of offering the additional option on a website.

17. The non-transitory computer-readable storage medium of claim 12, wherein the custom product is a window covering product.

18. The non-transitory computer-readable storage medium of claim 17, wherein the types of window covering product comprising at least one of blind, shade, and shutter.

19. The non-transitory computer-readable storage medium of claim 17, wherein the categories includes at least one of aluminum venetian blinds, faux wood venetian blinds, single-cell cellular shades, double-cell cellular shades, roller shades, roman shades, plastic shutters, MDF shutters, and wood shutters.

20. The non-transitory computer-readable storage medium of claim 12, wherein the fixed price includes shipping cost.

21. The non-transitory computer-readable storage medium of claim 12, wherein the processor further performs the step of offering an optional installation service.

22. The non-transitory computer-readable storage medium of claim 21, wherein the processor further performs the steps of:
determining a surcharge for the optional installation service; and
offering the optional installation service at the store.

23. The non-transitory computer-readable storage medium of claim 12, wherein the number of categories and sizes in each category is limited to reduce a need for display space in the store for displaying the custom product.
